(19) United States
(12) Patent Application Publication
(10) Pub. No.: US 2005/0221888 A1
(43) Pub. Date: Oct. 6, 2005

(54) Medal acceptance device

(76) Inventors: Hideaki Kishi, Tokyo (JP); Kenichi Fujimori, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/097,384

(22) Filed: Apr. 4, 2005

(30) Foreign Application Priority Data
Apr. 5, 2004 (JP) P2004-110829

(51) Int. Cl. G06F 17/00

(52) U.S. Cl. 463/25

(57) ABSTRACT

A medal acceptance device includes a gaming medal detecting means detecting a gaming medal inserted through a medal insertion slot and a value data storage means storing first value data representing a gaming value of the gaming medal. The medal acceptance device further detects a setting medal inserted through the medal insertion slot and having a data storage part capable of storing second value data different from the first value data; detects the second value data stored in the data storage part of the setting medal; and changes the first value data stored in the value data storage means to the detected second value data. Further, the medal acceptance device erases the second value data stored in the data storage part of the detected setting medal.

### CROSS REFERENCE TO RELATED APPLICATIONS

This application is based upon and claims the benefit of priority from the prior Japanese Patent Application No. 2004-110829, filed on Apr. 5, 2004 the entire contents of which are incorporated herein by reference.

### BACKGROUND OF THE INVENTION

1. Field of the Invention

The present invention relates to a medal acceptance device, installed or incorporated in a gaming machine such as a slot machine, a roulette gaming machine, or the like, capable of changing the gaming value of gaming medals.

2. Related Art

Gaming machines such as a slot machine, a roulette gaming machine, a card gaming device are known which use gaming media such as medals, coins, tokens, chips, and so on. Games played on these kinds of gaming machines are those that players can start by purchasing or borrowing (hereinafter referred to as “purchasing or the like”) medals as gaming media from a medal lending machine and inserting the medals into the gaming machines (so-called medal games). The gaming machine on which the medal game can be played (hereinafter referred to as “medal gaming machine”) pays out a predetermined number of medals to the player winning the game. Therefore, the player who could acquire medals can continuously enjoy playing the game without purchasing or the like medals again.

Incidentally, in the case of conventional medals for use in the medal gaming machine, the value per medal when it is used in the medal gaming machine (that is the value of credit or the like allowing the medal game to be played and also called as the “gaming value”) has been invariably fixed. Accordingly, the value of the number of executable games, credits, or the like per amount of money of purchasing or borrowing medals has been previously determined for each gaming arcade.

Hence, Patent Document 1 (Japanese Unexamined Patent Publication No. 2000-317128, pp. 4-6, FIG. 4 to FIG. 5) describes a medal lending machine in which a payout for each time zone is stored in a payout storage table (a payout stored therein is called a “stored payout”) so that a press of an operation button by a user allows a corresponding stored payout to be read and medals to be paid out corresponding to the stored payout. In such a medal lending machine, the gaming value per medal for use in the medal gaming machine is never changed, but the medal payout per purchase amount of money from the medal lending machine may be changed depending on a day of the week and time zone in a day. Therefore, in this medal lending machine, the number of executable games, credits, or the like per amount of purchasing medals can be changed by changing the number of medals per predetermined amount of money, thereby producing an effect of further attracting customers.

### SUMMARY OF THE INVENTION

The medal lending machine described in Patent Document 1, however, changes the payout of medals, in accordance with the payout storage table, in the same time zone or the same day of the week without exception. Accordingly, the gaming arcade side could not change the payout of medals at a voluntary timing. Further, it is also necessary to perform a troublesome operation for change of the payout storage table itself, and provision of a device or system required for the change may result in increased cost on the gaming arcade side.

Besides, the invention described in Patent Document 1 is configured such that the number of medals that can be purchased or the like in a predetermined amount of money is changed but not configured such that the gaming value per medal is changed. Accordingly, when a player purchases or the like a large quantity of medals where the stored payout is large, carriage of the medals purchased or the like and reservation of a place for them are difficult, which might have reduced the desire of the player to play games. Besides, the number of executable games, credits, or the like per amount of purchasing or borrowing medals is changed based not on date and hour when games are played but on date and hour when the medals are purchased or the like, leading to such a predictable situation that players only purchase or the like medals when the stored payout is large and do not play medal games. This has been a factor in reduction by half in the effect of attracting customers.

The present invention has been developed to solve the above-described problems in the prior art, and its object is to provide a medal acceptance device capable of changing the gaming value per medal without the necessity of huge facilities, systems, and so on, and changing the number of executable games, credits, or the like per amount of money of purchasing or borrowing medals, at an arbitrary timing on a gaming arcade side.

To solve the above problems, the present invention is characterized in that a medal acceptance device including a gaming medal detecting means detecting a gaming medal inserted through a medal insertion slot and a value data storage means storing first value data representing a gaming value of the gaming medal, the device including: a setting medal having a data storage part capable of storing second value data different from the first value data representing the gaming value of the gaming medal; a setting medal detecting means detecting the setting medal inserted through the medal insertion slot; a data detecting means detecting the second value data stored in the data storage part of the setting medal inserted through the medal insertion slot; a data change means changing the first value data stored in the value data storage means to the second value data detected by the data detecting means; and a data erasing means erasing the second value data stored in the data storage part of the setting medal detected by the setting medal detecting means.

Further, in the above-described medal acceptance device, it is preferable that the setting medal has medal identification information stored in the data storage part; that the gaming medal has an identification information storage part in which medal identification information is stored; and that the device further includes: a confirmation identification information storage means storing confirmation identification information for determining whether the gaming medal and setting medal are right or wrong; an identification information detecting means detecting medal identification information of the setting medal or the gaming medal inserted through the medal insertion slot; a checking means checking the medal identification information detected by the identification information detecting means against the confirmation identification information; and a determination means performing, based on a check result by the checking means, a right/wrong determination of whether or not a medal inserted through the medal insertion slot is an authorized medal.

Further, it is also possible to further include an error control means performing control to shift to an error state in which medal insertion through the medal insertion slot is not accepted, when the determination means determines that the setting medal or gaming medal inserted through the medal insertion slot is not an authorized medal.

Further, it is also possible to further include a display means displaying the first value data or the second value data.

Furthermore, it is possible to further include a medal holding means holding, when the determination means determines that the setting medal or gaming medal inserted through the medal insertion slot is not an authorized medal, the setting medal or gaming medal determined by the determination means.

Further, the display means preferably performs a warning display when the determination means determines that the setting medal or gaming medal inserted through the medal insertion slot is not an authorized medal.

The above-described medal acceptance device may further include an error release means for releasing the error state.

Further, it is also possible to further include a medal housing unit housing both the setting medal and gaming medal determined to be authorized medals by the determination means.

The present invention will be more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is an external appearance perspective view showing a schematic configuration of a roulette gaming machine according to this embodiment;

FIG. 2 is a plan view of a roulette wheel according to this embodiment;

FIG. 3 is a view showing an example of a display screen to be displayed on an image display device;

FIG. 4 is a perspective view showing a medal acceptance device according to this embodiment;

FIG. 5 is a cross-sectional view of the medal acceptance device cut along a yz plane passing a medal insertion slot;

FIG. 6 is a schematic view showing a display example of a medal value display unit in an error state;

FIG. 7 is a plan view showing an external appearance of a gaming IC medal according to this embodiment;

FIG. 8 is a cross-sectional view with hatchings of the gaming IC medal cut along an B-B line in FIG. 7;

FIG. 9 is a schematic view showing storage areas of an electronic tag of the gaming IC medal according to this embodiment;

FIG. 10 is a plan view showing an external appearance of a setting IC medal according to this embodiment;

FIG. 11 is a cross-sectional view with hatchings of the setting IC medal cut along an C-C line in FIG. 10;

FIG. 12 is a schematic view showing storage areas of an electronic tag of the setting IC medal according to this embodiment;

FIG. 13 is a block diagram schematically showing a control system of the roulette gaming machine according to this embodiment;

FIG. 14 is a block diagram schematically showing a control system of a satellite according to this embodiment;

FIG. 15 is a schematic view showing a storage area of a ROM of the medal acceptance device according to this embodiment;

FIG. 16 is a schematic view showing a storage area of a RAM of the medal acceptance device according to this embodiment;

FIG. 17 is a flowchart showing an operation procedure of main processing in the medal acceptance device according to this embodiment; and

FIG. 18 is a flowchart showing an operation procedure of medal acceptance processing in the medal acceptance device according to this embodiment.

### DESCRIPTION OF THE PREFERRED EMBODIMENTS

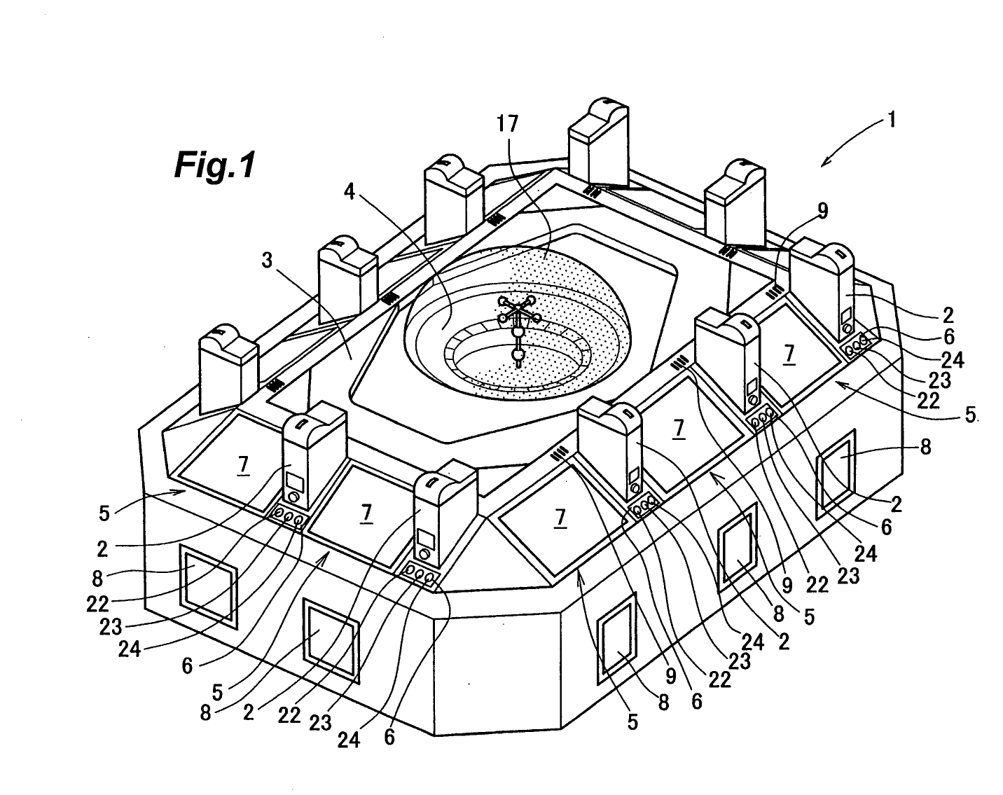

A medal acceptance device according to the present invention will be described in detail below based on an embodied example with reference to the drawings. The medal acceptance device according to the present invention is installed or incorporated in various medal gaming machines such as a slot machine, a roulette gaming machine, a card gaming device, and so on which use medals as gaming media, and is used. In this embodiment, a medal acceptance device 2 incorporated in a roulette gaming machine 1 shown in FIG. 1 will be described as an example. It should be noted that the roulette gaming machine 1 is a gaming machine on which a roulette game can be played. In the roulette game, a player predicts a number to be determined by roulette and bets possessing gaming media such as medals or the like on the predicted number or the like, so that when the number bet on or the like wins, the player can receive payout of a predetermined number of medals.

(Description of Roulette Gaming Machine)

First of all, a schematic configuration of the roulette gaming machine 1 incorporating the medal acceptance device according to the embodiment of the present invention will be described with reference to FIG. 1. FIG. 1 is an external appearance perspective view showing the schematic configuration of the roulette gaming machine 1. As shown in FIG. 1, the roulette gaming machine 1 has a cabinet 3 being a main body, a roulette wheel 4 provided almost at the center portion of an upper face of the cabinet 3, and a plurality of (ten in this embodiment) satellites 5 set around the roulette wheel 4 to surround the roulette wheel 4. The satellite 5 here is a gaming unit having at least the medal acceptance device 2 into which medals to be used for games are inserted, a control panel 6 composed of a plurality of control buttons and so on through which a predetermined instruction is inputted by a player, and an image display device 7 which displays images associated with the game. The player can operate the control panel 6 and the like on each of the satellites 5 while looking at the images displayed on the image display device 7 to cause a developed roulette game to proceed. Further, a medal payout opening 8 is provided on a side face of the cabinet 3 in correspondence with each of the satellite 5. Furthermore, a speaker 9 that presents music, sound effects, and so on is provided at the upper right of the image display device 7 within each of the satellites 5.

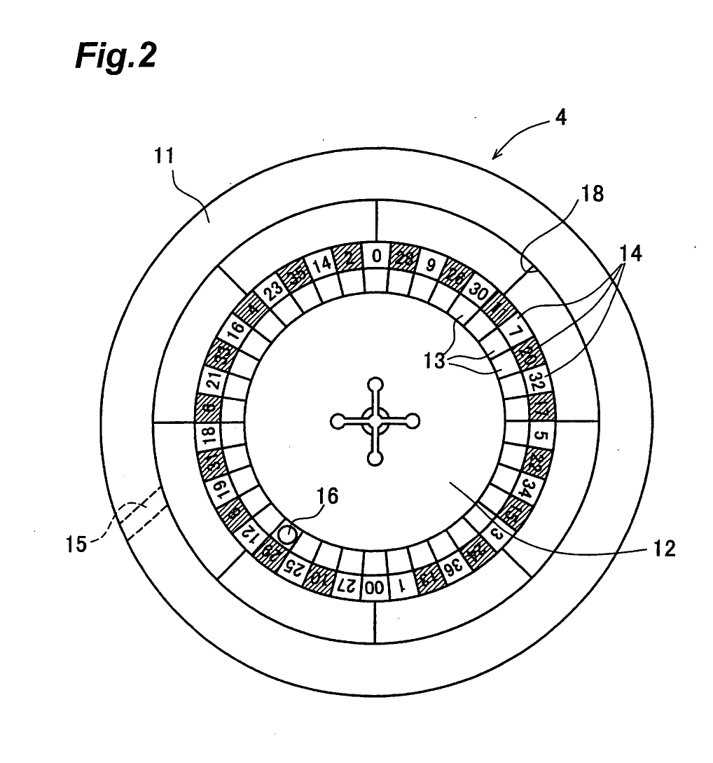

Next, a configuration of the roulette wheel 4 of the roulette gaming machine 1 will be described with reference to FIG. 2. FIG. 2 is a plan view of the roulette wheel 4 of the roulette gaming machine 1. As shown in FIG. 2, the roulette wheel 4 has a frame 11 fixed to the cabinet 3, and a rotary wheel 12 housed and supported to be rotatable inside the frame 11. The rotary wheel 12 is formed on its upper face with a number of recessed pockets 13 (38 pockets in this embodiment). The rotary wheel 12 is also formed with a number display plates 14 outside each of the pockets 13. The number display plates 14 have numbers “0,” “00,” and “1” to “36” as graphic characters in a manner to correspond to the pockets 13.

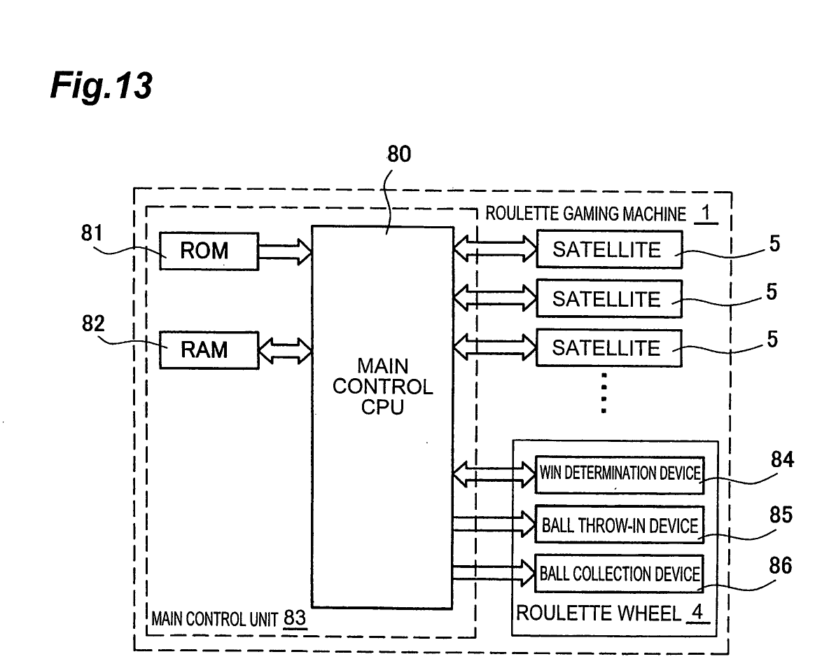

Further, the frame 11 has a ball throw-in port 15 formed therein. To the ball throw-in port 15, a later-described ball throw-in device 85 (FIG. 13) is coupled. From the ball throw-in port 15, a ball 16 is to be thrown onto the rotary wheel 12 by driving of the ball throw-in device 85. Further, the entire upper portion of the roulette wheel 4 is covered by a transparent acrylic cover member 17 in a hemispherical shape.

The frame 11 slopes gently from the outer side to the inner side and is formed with a guide wall 18 at a middle portion in the radial direction. The guide wall 18 serves to roll the thrown-in ball 16 while guiding it against the centrifugal force. When the ball 16 gradually decreases in speed going around on the frame 11 and finally loses its centrifugal force, the ball 16 tumbles down the slope of the frame 11 inward to reach the rotating rotary wheel 12. The ball 16 when reaching the rotary wheel 12 passes over the number display plates 14 and falls into any of the pockets 13 as shown in FIG. 2. The number described on the number display plate 14 corresponding to the pockets 13 into which the ball 16 has fallen is the winning number.

Further, a later-described win determination device 84 (shown FIG. 13) is installed at a position inside the cabinet 3 and below the roulette wheel 4. The win determination device 84 is a device for determining in what number of the pocket 13 the ball 16 has been accommodated. Further, a later-described ball collection device 86 (shown FIG. 13) is installed at a position inside the cabinet 3 and below the rotary wheel 12. This ball collection device 86 is a device that collects the ball 16 on the rotary wheel 12 after the end of the game. Incidentally, the win determination device 84, the ball throw-in device 85, and the ball collection device 86 are already known, and the description thereof here is therefore omitted.

Next, configurations of the control panel 6 and the image display device 7 of the roulette gaming machine 1 will be described.

The control panel 6 is provided beside the image display device 7 as shown in FIG. 1 and has buttons arranged which are operated by the player. Specifically, the control panel 6 has a BET decision button 22, a CASHOUT button 23, and a HELP button 24 arranged in order from the left side as seen from the front side of the satellite 5.

The BET decision button 22 is a button to be pressed when a bet is decided after a betting operation through the image display device 7. Then, when a bet has been decided and medals are kept bet, during the game, on the number of the number display plate 14 corresponding to the pocket 13 into which the ball 16 has fallen, the bet wins. For the win, credits corresponding to the number of bet chips are added to the credits possessed by the player. Note that the betting operation will be described later in detail.

The CASHOUT button 23 is a button to be pressed generally at the end of the game. When the CASHOUT button 23 is pressed, medals corresponding to the credits possessed by the player which has been acquired by the game and so on (generally, one medal for one credit) are paid out through the medal payout opening 8.

The HELP button 24 is a button to be pressed when the player does not know how to operate the game or the like. When the HELP button 24 is pressed, immediately thereafter a help screen indicating various kinds of operation information is displayed on the image display device 7.

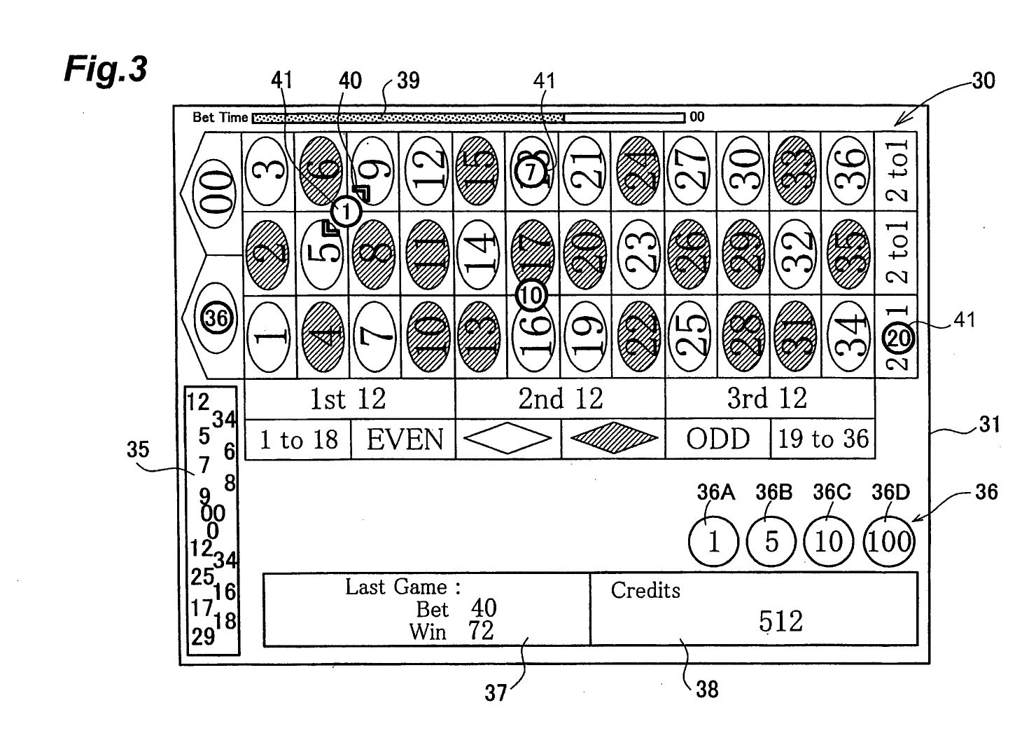

The image display device 7 is a so-called touch panel liquid crystal display with a touch panel 28 being attached to the front face. The image display device 7 is configured such that a press with a finger or the like of an icon displayed on the liquid crystal display can activate the touch panel 28 so as to select the icon. Here, FIG. 3 is a view showing an example of the display screen to be displayed on the image display device 7 during the game.

As shown in FIG. 3, on the image display device 7, a BET screen 31 having a betting board 30 of table-type is to be displayed during execution of the roulette game by the roulette gaming machine 1. Then, the player can perform operation referring to the BET screen 31 to make a betting chips using the credits in hand.

The BET screen 31 will be described below based on FIG. 3. On the betting board 30 displayed on the BET screen 31, numbers arranged in a pattern of rectangles are displayed similarly to the numbers “0,” “00,” and “1” to “36” displayed on the number display plates 14. Further, special BET areas for betting chips with designation of “odd numbers,” “even numbers,” “the kind of color (red or black) of the number display plate,” “the range of certain numbers (for example, “1” to “12” or the like), are also arranged similarly in a pattern of rectangles.

Further, in addition to the betting board 30, a result history display section 35, a unit BET button 36, a cashout result display section 37, and a credit number display section 38 are displayed on the BET screen 31 in order from the left side.

In the result history display section 35, the results of winning numbers in the games so far are listed (one game here referring to a series of operations starting from player making bets through the satellites 5, and the ball 16 falling into one of the pockets 13, to payout of credits being performed based on the winning number). In this event, a new winning number is added and displayed from above after the end of one game, so that the winning numbers for a maximum of 16 games can be checked.

The unit BET button 36 is a button for betting on a BET area designated by the player (on a rectangle with a number and a mark, or on a line forming rectangles). The unit BET button is composed of four kinds of buttons, that is, a 1BET button 36A, a 5BET button 36B, a 10BET button 36C, and a 100BET button 36D.

The player first directly presses with a finger or the like a BET area where the number to bet is displayed on the screen of the betting board 30, thereby designating the BET area by a later-described cursor 40. By pressing the 1BET button 36A in this state, the player can bet chips one by one (the number of chips to be bet increasing in order of “1”→“2”→“3”→ etc. every time the player presses the 1BET button 36A with a finger). On the other hand, by pressing the 10BET button 36C, the player can bet chips in units of ten (the number of medals to be bet increasing in order of “10”→“20”→“30”→ etc. every time the player presses the 10BET button 36C with a finger). This also applies to the operations of the 5BET button 36B and the 100BET button 36D. Thus, the operation even when betting a large quantity of chips can be simplified.

Besides, on the cashout result display section 37, the number of chips bet by the player and the number of credits paid out in the previous game are displayed. The number obtained by subtracting the number of bet medals from the number of payout credits is the number of credits that the player has newly acquired by the previous game.

Further, on the credit number display section 38, the number of credits possessed by the player is displayed. The number of credits decreases according to the number of chips bet by the player (one credit per chip). When the number on which chips are bet wins and credits are paid out, the number of paid-out credits are added. Incidentally, when the number of credits possessed by the player becomes 0 (zero), the game ends.

Further, a BET timer graph section 39 is provided at an upper side of the betting board 30. A bar graph indicating the residual time during which the player can make a bet is displayed on the BET timer graph section 39. In the BET timer graph section 39, a red bar graph starts to extend gradually to the right from the start of the game and reaches the rightmost position, which is the timing when the time to bet ends for the game being played. Besides, when the bar graph in the BET timer graph section 39 reaches a specific position (for example, a position of two thirds thereof), the ball 16 is thrown into the roulette wheel 4 from the ball throw-in device 85.

Further, on the betting board 30, the cursor 40 is displayed which indicates the BET area which the player selects. In addition, the number of chips bet until the present moment and chip marks 41 indicating BET areas are displayed, the number indicated on the chip mark 41 showing the number of bet chips. For example, the chip mark 41 with “7” that is placed on the rectangle of “18” as shown in FIG. 3 means that seven chips are bet on the number “18.” The method of betting on only one number as described above is a betting method called “Straight Up.”

Besides, the chip mark 41 with “1” that is placed on the intersection of the rectangles of “5,” 6,” “8,” and “9” means that one chip is bet to cover the four numbers “5,” 6,” “8,” and “9.” Note that the method of betting on four numbers as described above is a betting method called “Corner Bet.”

Other betting methods include “Split Bet” to place a bet on a line between two numbers to cover the two numbers, “Street Bet” to place a bet on the end of a row (a line in the vertical direction in FIG. 3) of numbers to cover three numbers (for example, “13,” “14,” and “15”), “Five Bet” to place a bet on a line between the numbers “00” and “3” to cover five numbers “0,” “00,” “1,” “2,” and “3”, Line Bet” to place a bet between numbers of two rows (two lines in the vertical direction in FIG. 3) of numbers to cover six numbers (for example, “13,” “14,” “15” “16,” “17,” and “18”), “Column Bet” to place a bet on a rectangle written with “2 to 1” to cover 12 numbers, and “Dozen Bet” to place a bet on a rectangle written with “1st 12,” “2nd 12,” or “3rd 12” each to cover 12 numbers. There is a still another method of placing a bet on the color of the number display plate (“red” or “black”), whether the number is an odd number or even number, or whether the number is 18 or lower or 19 or higher, using six rectangles provided at the lowermost tier in the betting board 30, so as to cover 18 numbers.

When placing a bet through use of the BET screen 31 configured as described above, the player first directly presses the touch panel with a finger to designate on the screen the BET area to bet (on a rectangle with a number and a mark or on a line forming rectangles). As a result, the cursor 40 moves to the designated BET area. Thereafter, a press of each of the unit buttons of the unit BET button 36 (the 1BET button 36A, the 5BET button 36B, the 10BET button 36C, and the 100BET button 36D) places a bet of chips corresponding to the unit on the designated BET area. For example, presses of the 10BET button 36C four times, the 5BEt button 36B one time, and 1BET button 36A three times allow 48 chips in total to be bet.

(Description of Medal Acceptance Device)

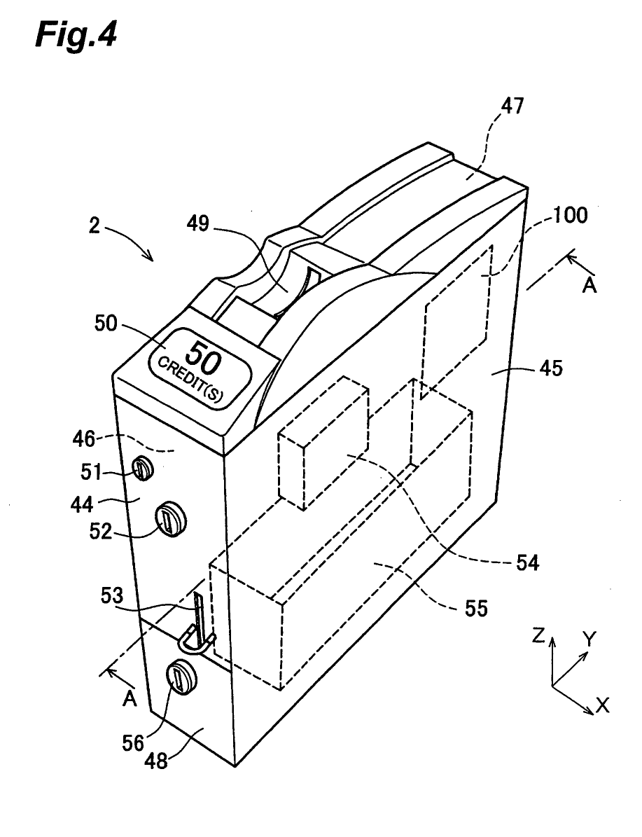

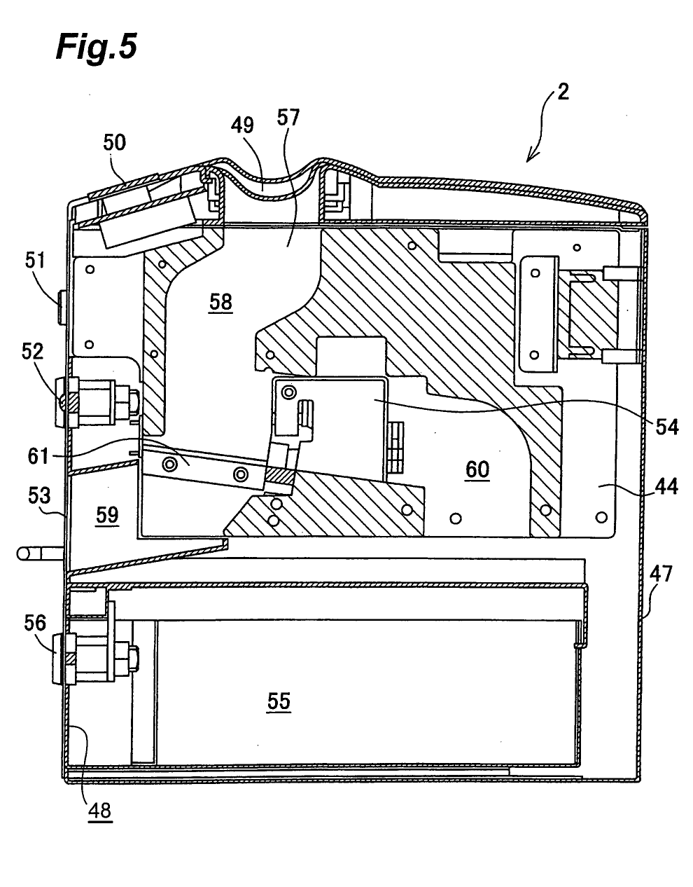

Next, a configuration of the medal acceptance device 2 according to this embodiment will be described with reference to FIG. 4 and FIG. 5. FIG. 4 is a perspective view showing the medal acceptance device according to this embodiment, and FIG. 5 is a cross-sectional view of the medal acceptance device cut along a yz plane passing a medal insertion slot 49.

As shown in FIG. 4, the medal acceptance device 2 is a device having a main body in an almost parallelepiped shape and accepting IC medals inserted into the main body, the IC medal incorporating an electronic tag. Incidentally, the IC medals include a gaming IC medal 65 as a gaming medal of the present invention for the player to use in playing a game, and a setting IC medal 66 as a setting medal (a setting gaming medium) of the present invention to change the gaming value (the number of additional credits per medal) of the gaming IC medal 65. The IC medals employed for the gaming IC medal 65 and the setting IC medal 66 have the same configuration except that information stored in the electronic tag is different. Details on the gaming IC medal 65 and the setting IC medals 66 will be described later.

The medal acceptance device 2 has an acceptance device control unit 100 that performs various kinds of control of key switches and the medal acceptance device 2, a body unit 44 provided with paths and so on for allowing the medals to pass through, side walls 45, 46 and 47 supporting the body unit 44, and a base portion 48 provided below the body unit 44.

First of all, the body unit 44 of the medal acceptance device 2 will be described. The body unit 44 is provided with the medal insertion slot 49 as a gaming medium insertion slot into which the medals are inserted, a medal value display unit 50 as a display means in the present invention displaying the current gaming value of the gaming IC medal 65, an error release switch 51, a separation switch 52, a medal return slot 53 through which the medals are returned.

The medal insertion slot 49 here is an opening into which the gaming IC medal 65 and the setting medal 66 can be inserted. Into the medal insertion slot 49, the player who plays a medal game at the satellite 5 inserts the gaming IC medal 65 in increasing the number of credits for use in the game. The number of credits increases by the number of credits displayed on the medal value display unit 50 every time the player inserts one gaming IC medal 65. Incidentally, the number of credits possessed by the player (the number of possessed credits) is displayed on the credit number display section 38 of the BET screen 31.

The medal value display unit 50, which is composed of a 7-segment LED, displays, in the number of credits, the current gaming value per gaming IC medal 65. For example, when a numeral “50” is displayed on the medal value display unit 50 as shown in FIG. 4, which means that the gaming value is “50,” the gaming IC medal 65 inserted through the medal insertion slot 49 causes 50 credits per medal to be added to the number of credits in hand. Similarly to the above, when a numeral “100” is displayed, the gaming IC medal 65 inserted through the medal insertion slot 49 causes 100 credits per medal to be added to the number of credits in hand. In addition, the gaming value of the gaming IC medal 65 in these cases can be changed through use of the setting IC medal 66. Incidentally, the medal value display unit 50 is not limited to the 7-segment LED, but may be, for example, a liquid crystal display device. A procedure of changing the gaming value will be described later in detail.

The error release switch 51, which is an error release means in the present invention, is a key switch to be operated with its exclusive key (not shown) being inserted thereinto. The medal acceptance device 2 according to this embodiment detects unauthorized medals such as IC medals for other arcades or forged IC medals when they are inserted thereinto, and shifts to a state of not accepting insertion of medals thereafter (an error state), as described later. By operating the error release switch 51 (inserting the key thereinto and turning it to the left) during the error state, the medal acceptance device 2 is released from its error state to return again to a state capable of accepting medals.

The separation switch 52 is a key switch to be operated in a similar manner with its exclusive key (not shown) being inserted thereinto. By operating the separation key 52 (inserting the key thereinto and turning it to the right), a fixing device (not shown) fixing the body unit 44 is released from the locked state, so that the body unit 44 is separated from the side walls 45, 46 and 47 and the base portion 48. When the medal acceptance device 2 shifts to the error state because an unauthorized medal is inserted thereinto as described later, the medal acceptance device 2 holds the inserted medal in a later-described medal holding unit 54 (see FIG. 5). It should be noted that the error state continues until it is released by the error release switch 51, but during the error state, the medal held in the medal holding unit 54 can be taken out by separating the body unit 44. In addition, maintenance or the like of the inside of the body unit 44 can be performed. Note that the separation switch 52 and the error release switch 51 can be operated only by the gaming arcade, but not by players.

The medal return slot 53 is a return slot for returning a medal when it is inserted through the medal insertion slot 49, the medal being of a different type from that of the gaming IC medal 65 and the setting IC medal 66. Note that medals of different types from those of the gaming IC medal 65 and the setting IC medal 66 include, for example, a 100 yen coin, a 10 cent coin different in size (diameter) and weight, an ordinary medal including no electronic tag, and so on.

Next, the base portion 48 will be described. In the base portion 48, a medal housing unit (a gaming medium housing unit) 55 is installed in which inserted medals are to be housed. Further, the base portion 48 can be slid to move forward relative to the side walls 45, 46 and 47 (to the left in FIG. 5), so that the movement allows the medals housed in the medal housing unit 55 to be collected. Further, a housing unit opening/closing switch 56 is provided on the front face of the base portion 48.

The housing unit opening/closing switch 56 is a key switch to be operated with its exclusive key (not shown) being inserted thereinto. By inserting a predetermined key and turning it in a predetermined direction, a locking device (not shown) of the base portion 48 is released from the locked state. The release of the locked state allows the base portion 48 to be slid relative to the medal acceptance device 2 and drawn forward.

Next, the internal structure of the medal acceptance device 2 will be described using FIG. 5. As shown in FIG. 5, the body unit 44 of the medal acceptance device 2 is formed with a medal path 57 through which medals inserted through the medal insertion slot 49 pass. At an almost middle point of the medal path 57, the medal holding unit 54 is provided as a medal holding means in the present invention. The medal holding unit 54 is provided with a not-shown medal detecting unit, electronic tag reader/writer, and medal holding device separately.

The medal path 57 has a first guide path 58, a second guide path 59, and a third guide path 60. The first guide path 58 is a path that guides a medal inserted through the medal insertion slot 49 to the medal holding unit 54. The second guide path 59 is a path that guides, to the medal return slot 53, a medal where it has been guided by the first guide path 58 and is of a different type in size, weight, or the like (for example, a 100 yen coin, a 10 cent coin or an ordinary medal including no electronic tag). The third guide path 60 is a path that guides, to the medal housing unit 55, a medal which has passed through the medal holding unit 54.

Further, a medal return device 61 is provided at a boundary between the first guide path 58 and the second guide path 59. The medal return device 61 is a device that automatically leads to the second guide path 59 the medal of the different type when the medal inserted through the medal insertion slot 49 passes from the first guide path 58 to the third guide path 60.

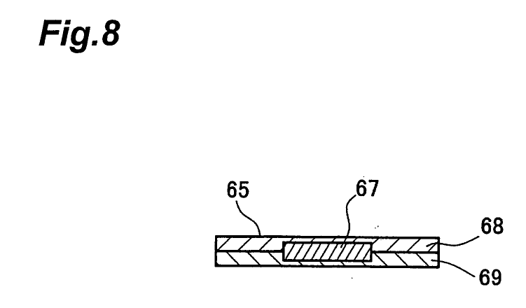

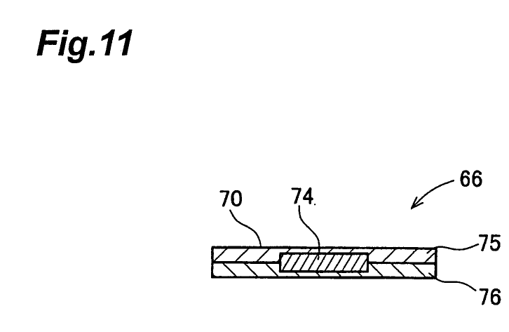

The medal holding unit 54 includes the medal detecting unit, electronic tag reader/writer, and medal holding device. In the medal holding unit 54, the medal detecting unit detects the gaming IC medal 65 and the setting IC medal 66 led from the first guide path 58. Besides, the electronic tag reader/writer reads and writes data stored in electronic tags 67, 74 (see FIG. 8, FIG. 11) of the detected gaming IC medal 65 and setting IC medal 66.

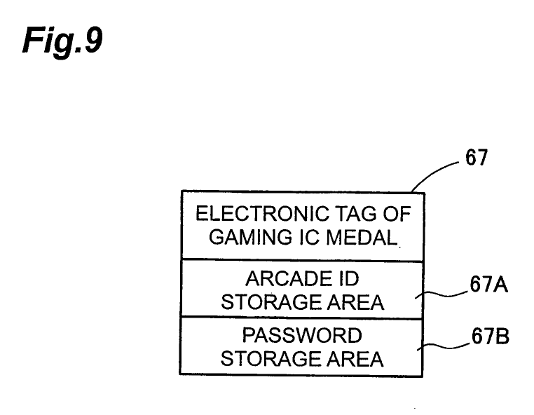

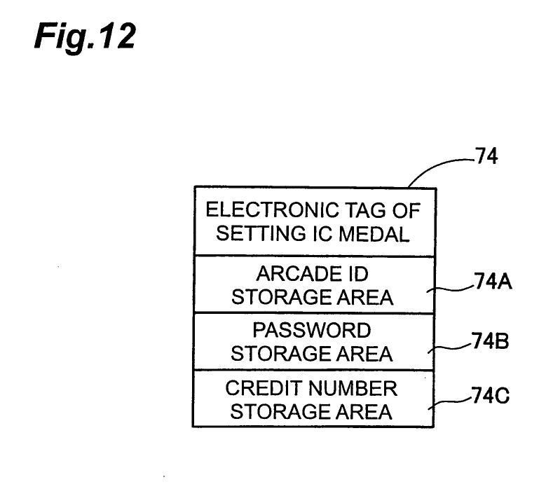

In the electronic tag 67, 74 here, an arcade ID and a password (see FIG. 9, FIG. 12) are stored as medal identification information (gaming medium identification information) in the present invention as described later, so that the arcade ID and password are read and subjected to a right/wrong determination (also called a medal authenticity determination) of whether it is an authorized medal or not.

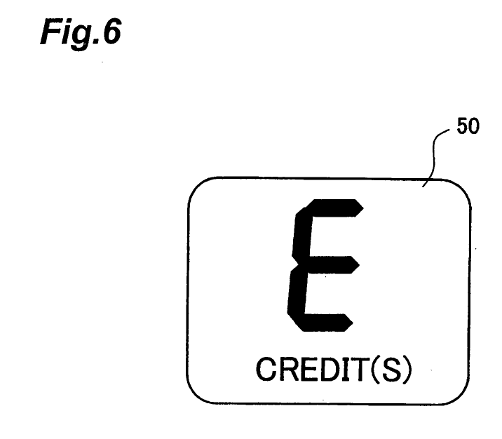

When the acceptance device control unit 100 determines that the inserted medal is not the authorized medal, the determined medal is held in the medal holding unit 54 by the medal holding device, and a character “E” indicating an error state is displayed on the medal value display unit 50. Furthermore, all of the medals inserted thereafter are led by the medal return device to the medal return slot 53. FIG. 6 is a schematic view showing the medal value display unit 50 in the error state.

The medal acceptance device 2 is configured to shift to the error state not to accept medals inserted by the player who has used the unauthorized medal, thereafter. Further, the medal acceptance device 2 is configured to be able to give a warning to the player and inform the gaming arcade of the fact. Accordingly, the medal acceptance device 2 is configured to prevent the player who has committed an injustice from continuously playing a medal game any more.

On the other hand, when the inserted medal is determined to be the authorized medal by the acceptance device control unit 100 and the inserted medal is the gaming IC medal 65, the inserted medal is guided to the medal housing unit 55 as it is. When the inserted medal is the setting IC medal 66, it is guided to the medal housing unit 55 after a portion of data (a credit number storage area 74C) stored in the setting IC medal 66 is erased by the electronic tag reader/writer. It should be noted that the setting IC medal 66 which is erased a portion of data by the electronic tag reader/writer have an appearance and contents of data in common with the gaming IC medal. The setting IC medal 66 can be used as a gaming IC medal 65.

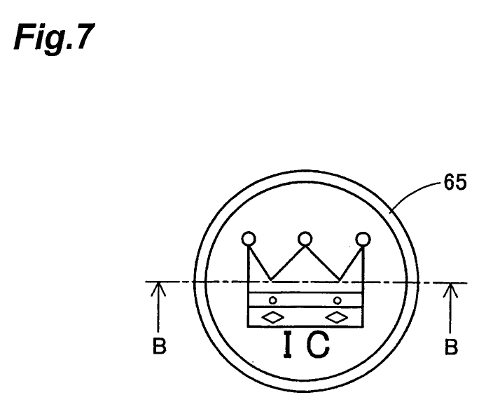

Next, configurations of the IC medals for use in the medal acceptance device 2 according to this embodiment will be described with reference to FIG. 7 to FIG. 12. The IC medals for use in the medal acceptance device 2 are basically classified into two kinds, that is, the above-described gaming IC medal 65 and setting IC medal 66 according to contents of data stored therein. Incidentally, the gaming IC medal 65 and setting IC medal 66 have the same structure but are different only in the contents of data stored therein.

The gaming IC medal 65 is a medal that the player should purchase or the like to start a medal game separately with a predetermined amount of money (for example, a 500 yen, 5 dollars), from an exclusive IC medal lending machine (not shown) installed in the gaming arcade. By inserting the gaming IC medal 65 through the medal insertion slot 49 to increase the number of credits in player's hand, the player can start the medal game.

On the other hand, the setting IC medal 66 is a medal possessed only by the gaming arcade side and cannot be used by players. The setting IC medal 66 is made by adding special data to the gaming IC medal 65 using a data writing device (not shown). When the setting IC medal 66 is inserted through the medal insertion slot 49, the currently set gaming value of the gaming IC medal 65 is to be changed.

First, the gaming IC medal 65 will be described below. FIG. 7 is a plan view showing an external appearance of the gaming IC medal for use in the medal acceptance device 2 according to this embodiment. FIG. 8 is a cross-sectional view with hatchings of the gaming IC medal cut along an B-B line in FIG. 7.

As shown in FIG. 7 and FIG. 8, the gaming IC medal 65 is molded in a circular thin plate shape with a pattern (a symbol showing a crown in FIG. 7) designed for each gaming arcade using the medal drawn on its surface, and incorporates the electronic tag 67 of a non-contact type. The gaming IC medal 65 is formed by securing two base materials 68, 69 superposed one on the other with the electronic tag 67 sandwiched therebetween. The base materials 68, 69 are molded of a resin or an alloy.

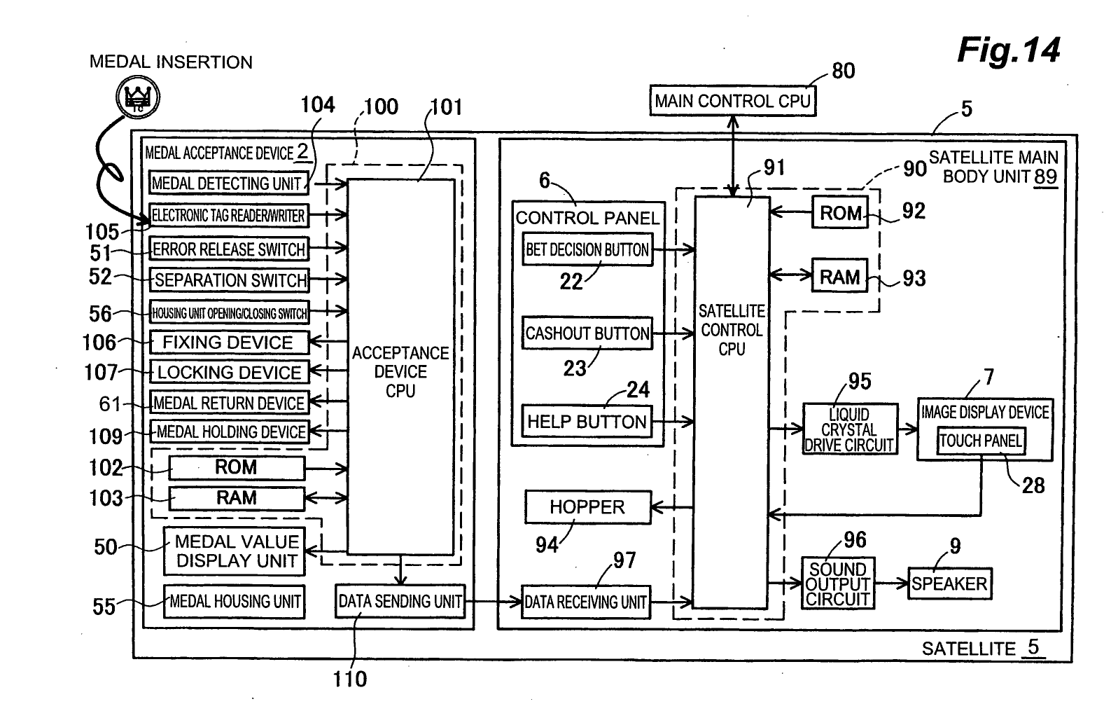

The electronic tag 67 here has an IC chip storing various kinds of information and an antenna coil electrically connected to the IC chip. The electronic tag 67 is a non-contact type electronic tag and capable of sending/receiving information to/from an electronic tag reader/writer 105 (see FIG. 14) provided inside the medal acceptance device 2. Specifically, the coil (not shown) provided in the electronic tag reader/writer 105 generates lines of magnetic force, so that when the antenna coil of the electronic tag 67 inside the gaming IC medal 65 inserted through the medal insertion slot 49 passes the lines of magnetic force, an induced electromotive force is generated in the antenna coil. The generated electromotive force is then fed to the IC chip as electric power, allowing the electronic tag 67 to send data in the IC chip to the electronic tag reader/writer 105.

The electronic tag 67, which is an identification information storage part in the present invention, further has an arcade ID storage area 67A and a password storage area 67B as shown in FIG. 9. In the arcade ID storage area 67A and the password storage area 67B, an arcade ID and a password are stored as the medal identification information. The arcade ID is an ID determined for each gaming arcade issuing the gaming IC medal 65, and the password is, for example, an array of characters or the like separately added to verify the authenticity of the gaming IC medal 65 (whether it is the authorized medal or not). The arcade ID and password of the inserted gaming IC medal 65 are read from the electronic tag 67 by the electronic tag reader/writer 105 and checked against the authorized arcade ID and password stored in a ROM 102. Thus, the medal acceptance device 2 performs the later-described right/wrong determination for the inserted gaming IC medal 65.

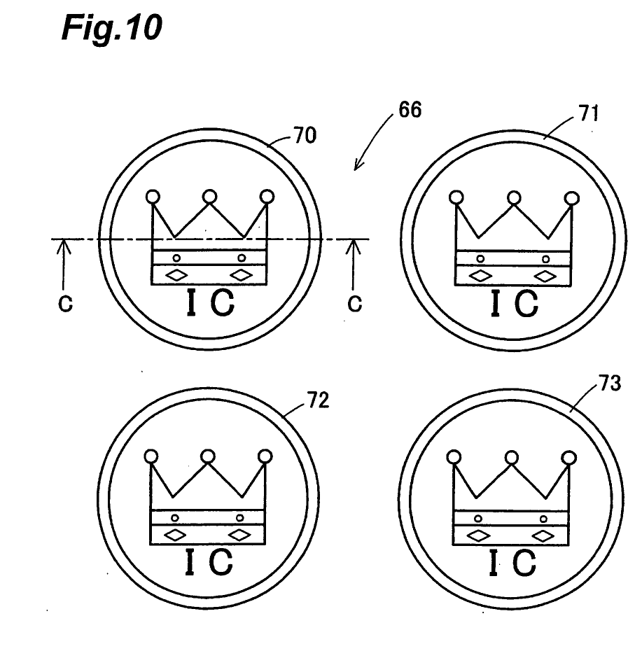

Next, the setting IC medal 66 will be described. FIG. 10 is a plan view showing an external appearance of the setting IC medal for use in the medal acceptance device 2 according to this embodiment. FIG. 11 is a cross-sectional view with hatchings of the setting IC medal cut along an C-C line in FIG. 10. As shown in FIG. 10, the setting IC medals 66 are classified into four kinds, in total, of medals. The setting IC medal 66 is inserted through the medal insertion slot 49 to change the current gaming value of the gaming IC medal 65 as described above, and the four kinds of medals are configured to be different in the gaming value to set.

Specifically, the setting IC medals 66 are classified into four kinds of medals, that is, a 30-credit setting IC medal 70, a 50-credit setting IC medal 71, a 70-credit setting IC medal 72, and a 100-credit setting IC medal 73. The credit setting medals 70 to 73 are set to add 30 credits, 50 credits, 70 credits, and 100 credits, respectively as the number of credits in hand, for each insertion of one gaming IC medal 65. The surfaces of the setting IC medals 66 are provided with the same pattern as that of the gaming IC medal 65.

As shown in FIG. 10 and FIG. 11, each of the credit setting IC medals 70 to 73 is also molded in a circular thin plate shape and incorporates the electronic tag 74 of a non-contact type. Each of the credit setting IC medals 70 to 73 is formed by securing two base materials 75, 76 superposed one on the other with the electronic tag 74 sandwiched therebetween. The base materials 75, 76 are molded of a resin or an alloy. Note that although only the cross-sectional view of the 30-credit setting IC medal 70 is shown in FIG. 11, the other credit setting IC medals 71 to 73 have the same cross-sectional shape. The following description is made taking the 30-credit setting IC medal 70 as an example.

The electronic tag 74, which is a data storage part in the present invention, has an IC chip storing various kinds of information and an antenna coil electrically connected to the IC chip. The electronic tag 74 is, similarly to the electronic tag 67, a non-contact type electronic tag and capable of, similarly to the electronic tag 67, sending/receiving information to/from the electronic tag reader/writer 105 (see FIG. 14) provided inside the medal acceptance device 2. Specifically, the coil (not shown) provided in the electronic tag reader/writer 105 generates lines of magnetic force, so that when the antenna coil of the electronic tag 74 inside the setting IC medal 66 inserted through the medal insertion slot 49 passes the lines of magnetic force, an induced electromotive force is generated in the antenna coil. The generated electromotive force is then fed to the IC chip as electric power, allowing the electronic tag 74 to send data in the IC chip to the electronic tag reader/writer 105.

The electronic tag 74 further has, as shown in FIG. 12, an arcade ID storage area 74A in which an arcade ID is stored, a password storage area 74B in which a password is stored, and a credit number storage area 74C in which the number of credits to be set as the gaming value of the gaming IC medal (the number of credits corresponds to a second value data in the present invention) is stored. The arcade ID is an ID determined for each gaming arcade issuing the setting IC medal 66, and the password is, for example, an array of characters or the like separately added to verify the authenticity of the setting IC medal 66 (whether it is the authorized medal or not). The arcade ID and password of the inserted setting IC medal 66 are read from the electronic tag 74 by the electronic tag reader/writer 105 and checked against the authorized arcade ID and password stored in the ROM 102. Thus, the medal acceptance device 2 performs the later-described right/wrong determination for the inserted setting IC medal 66. It should be noted that the arcade ID stored in the arcade ID storage area 74A and the password stored in the password storage area 74B are the same as the arcade ID stored in the arcade ID storage area 67A and the password stored in the password storage area 67B of the gaming IC medal 65.

Since the number of credits stored in the credit number storage area 74C is the number of credits for setting the gaming value per gaming IC medal 65, “30” is stored as the number of credits in the credit number storage area 74C of the 30-credit setting IC medal 70. Similarly, “50,” “70,” and “100” as the numbers of credits are stored in the 50-credit setting IC medal 71, the 70-credit setting IC medal 72, and the 100-credit setting IC medal 73, respectively. The number of credits of the inserted setting IC medal 66 are read by the electronic tag reader/writer 105. The number of credits read by the electronic tag reader/writer 105 is stored into the gaming IC medal value data storage area 103A of the RAM 103. Subsequently, in the medal acceptance device 2, the display on the medal value display unit 50 are changed to the changed number of credits, the gaming IC medal 65 is accepted based on the changed number of credits.

Further, into the credit number storage area 74C, the number of credits is to be written by the data writing device (not shown) provided in the gaming arcade. More specifically, in the gaming arcade, the setting IC medal 66 is created by writing information as the number of credits into the credit number storage area 74C of an arbitrary gaming IC medal 65 through use of the data writing device (not shown).

When the setting IC medal 66 are inserted into the medal acceptance device 2, the contents of the credit number storage area 74C of the inserted of the setting IC medal 66 is erased by the electronic tag reader/writer 105 after erasing of the gaming value data in RAM 103. Since the setting IC medal 66 which the contents of the credit number storage area 74C are erased will have an appearance and contents of storage data in common with the gaming IC medal 65, the setting IC medal 66 is housed in the medal housing unit 55 as a gaming IC medal 65.

(Configuration of Control System of Roulette Gaming Machine)

Next, a configuration of a control system of the roulette gaming machine 1 will be described with reference to FIG. 13. FIG. 13 is a block diagram schematically showing the configuration of the control system of the roulette gaming machine.

As shown in FIG. 13, the roulette gaming machine 1 is composed of a main control unit 83 including a main control CPU 80, a ROM 81, and a RAM 82, and the roulette wheel 4 and the ten satellites 5 (see FIG. 1) connected to the main control unit 83. Note that the control system of the satellite 5 will be described later in detail.

The main control CPU 80 executes various kinds of processing based on input signals and so on supplied from the satellites 5 and on the data and programs stored in the ROM 81 and RAM 82, and outputs based on the result a command signal to the satellites 5 to thereby control the satellites 5 in a leading manner, thus causing the roulette game to proceed. The main control CPU 80, to which the win determination device 84, the ball throw-in device 85, and the ball collection device 86 provided in the roulette wheel 4 are connected, controls the win determination device 84, the ball throw-in device 85, and the ball collection device 86 to throw the ball 16 into the roulette wheel 4, collect the ball 16 from the roulette wheel 4, and determine the winning number of the pocket 13 into which the ball has fallen.

The ROM 81, which is composed of, for example, a semiconductor memory or the like, stores a program for realizing the basic function of the roulette gaming machine 1, a program for controlling the devices in the roulette wheel 4, a program for controlling the satellites 5 in a leading manner, and so on.

On the other hand, the RAM 82 temporarily stores chip betting information supplied from the satellites 5, winning number data indicating a winning number determined by the win determination device 84, data on the result of the processing executed by the main control CPU 80, and so on.

The main control CPU 80 then activates the ball throw-in device 85 to throw the ball 16 into the roulette wheel 4, when the betting time for the player has passed to reach a certain time at each of the satellites 5, that is, when the above-described bar graph of the BET timer graph section 39 displayed on the BET screen 31 reaches the specific position (for example, the position of two thirds thereof).

When the ball 16 gradually decreases in the speed going around and finally loses its centrifugal force to tumble down the slope of the frame 11 into the pocket 13, the main control CPU 80 instructs the win determination device 84 to determine the number of the number display plate 14 corresponding to the pocket 13 into which the ball 16 has fallen and to input the determination result into the main control CPU 80. Thereafter, the main control CPU 80 instructs the ball collection device 86 to operate to collect the ball 16 from the top of the roulette wheel 4.

(Configuration of Control System of Satellite)

Next, a configuration of a control system of the satellite 5 will be described with reference to FIG. 14. FIG. 14 is a block diagram schematically showing the configuration of the control system of the satellite 5. It should be noted that the ten satellites 5 provided basically have the same configuration, and the following description will be made taking one of the satellites 5 as an example.

As shown in FIG. 14, the satellite 5 has a satellite main body unit (hereinafter, referred to as a “main body unit”) 89 provided with the image display device 7 and so on and the medal acceptance device 2 attached to the main body unit 89. The main body unit 89 is composed of a satellite control unit 90 and several peripheral devices. The satellite control unit 90 has a satellite control CPU 91, a ROM 92, and a RAM 93. The ROM 92, which is composed of, for example, a semiconductor memory or the like, stores a program for realizing the basic function of the satellite 5, other various programs, data tables and so on necessary for control of the satellite 5. On the other hand, the RAM 93 is a memory for temporarily storing various kinds of data calculated by the satellite control CPU 91, the number of credits possessed by the player, the state of medals bet by the player, and so on.

To the satellite control CPU 91, the BET decision button 22, CASHOUT button 23, and HELP button 24 which are provided in the control panel 6 (see FIG. 1) are separately connected. The satellite control CPU 91 then performs control based on operation signals outputted by presses or the like of the buttons so as to perform corresponding various operations. Specifically, the satellite control CPU 91 executes various kinds of processing based on an input signal supplied from the control panel 6 in response to input of the operation by the player and on the data and programs stored in the ROM 92 and RAM 93, and outputs the result to the main control CPU 80 of the main control unit 83. On the other hand, the satellite control CPU 91 controls the peripheral devices constituting the satellite 5 in accordance with a command signal inputted from the main control CPU 80, thereby causing the roulette game to proceed at the satellite 5. The satellite control CPU 91, depending on the contents of processing, also executes various kinds of processing based on the input signal supplied from the control panel 6 in response to input of the operation by the player and on the data and programs stored in the ROM 92 and RAM 93. The satellite control CPU 91 then controls the peripheral devices constituting the satellite 5 based on the result of the executed processing, thereby causing the roulette game to proceed at the satellite 5. Incidentally, which method is employed to execute the processing is set for each processing in accordance with the contents of the processing. For example, the medal payout processing for a winning number corresponds to the former processing, and the betting operation processing on the BET screen 31 by the player corresponds to the latter processing.

To the satellite control CPU 91, a hopper 94 is also connected. The hopper 94 pays out a predetermined number of medals through the medal payout opening 8 (see FIG. 1) in response to a command signal from the satellite control CPU 91.

Further, to the satellite control CPU 91, the image display device 7 is connected via a liquid crystal drive circuit 95. The liquid crystal drive circuit 95 is composed of a program ROM, an image ROM, an image control CPU, a work RAM, a VDP (Video-Display-Processor), a video RAM, and so on. The program ROM stores an image control program and various selection tables relating to display on the image display device 7. The image ROM stores, for example, dot data for forming an image to be displayed on the image display device 7. The image control CPU determines the image to be displayed on the image display device 7 from among the dot data previously stored in the image ROM, based on parameters set by the satellite control CPU 91 and according to the image control program previously stored in the program ROM. The work RAM is constituted as a temporary storage means when the image control program is executed by the image control CPU. The VDP forms an image corresponding to the display contents determined by the image control CPU and outputs it to the image display device 7. Incidentally, the video RAM is constituted as a temporary storage means when an image is formed by the VDP.

Further, the touch panel 28 is attached to the front face of the image display device 7. The operation information when the player operates the touch panel 28 is inputted into the satellite control CPU 91. On the touch panel 28, a medal betting operation by the player is performed at the BET screen 31. Specifically, the operation of the touch panel 28 is performed by selection of a BET area, operation of the unit BET button 36, and so on, and operation information corresponding to the operation is inputted into the satellite control CPU 91. Then, based on the inputted operation information, various kinds of processing such as switching of screens and so on are performed.

Further, a sound output circuit 96 and the speaker 9 are connected to the satellite control CPU 91. The speaker 9 generates various kinds of sound effects when presenting various kinds of effect based on an output signal from the sound output circuit 96.

To the satellite control CPU 91, a data receiving unit 97 is also connected. The data receiving unit 97 receives a credit signal sent from the medal acceptance device 2. The credit signal has, as described later, information on the number of additional credits based on the gaming value data representing the current gaming value of the gaming IC medal 65 acquired by the medal acceptance device 2 when the gaming IC medal 65 is inserted into the medal acceptance device 2. The satellite control CPU 91 increases the number of credits of the player stored in the RAM 93 based on the sent credit signal.

Next, the medal acceptance device 2 attached to the main body unit 89 will be described. The medal acceptance device 2 is composed of the acceptance device control unit 100 and several peripheral devices. The acceptance device control unit 100 has an acceptance device CPU 101, a ROM 102, and a RAM 103. The acceptance device CPU 101 executes various kinds of processing based on the data and programs stored in the ROM 102 and RAM 103 and causes the data sending unit 110 to sent the later-described credit signal based on the result to the satellite 5.

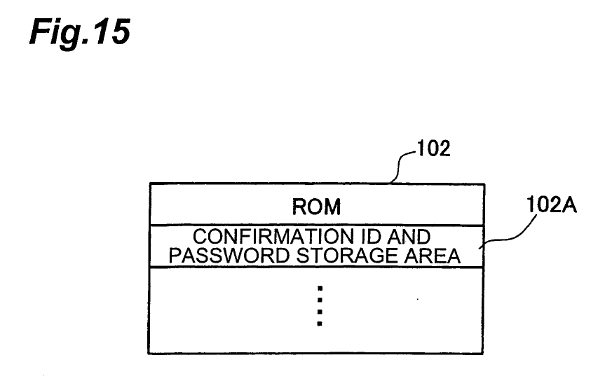

The ROM 102, which is composed of, for example, a semiconductor memory or the like, stores a program for realizing the basic function of the medal acceptance device 2. The ROM 102 also has, as shown in FIG. 15, a confirmation ID and password storage area 102A, and thus has a function as a confirmation identification information storage means in the present invention. In the confirmation ID and password storage area 102A, a confirmation arcade ID and password as confirmation identification information in the present invention are stored for performing the right/wrong determination for the gaming IC medal 65 and setting IC medal 66. Further, the ROM 102 additionally stores various kinds of programs, data tables, and so on necessary for control of the medal acceptance device 2.

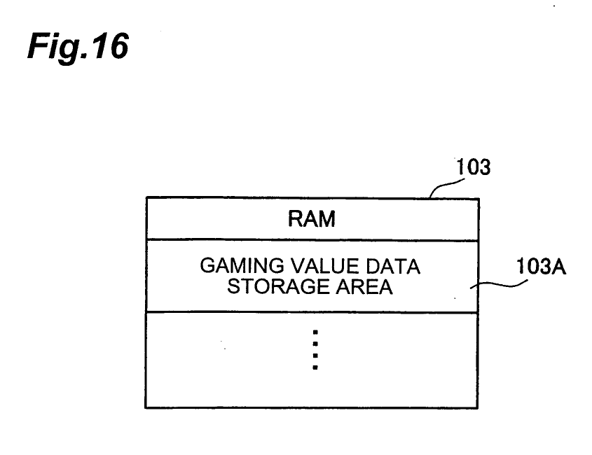

On the other hand, the RAM 103 has, as shown in FIG. 16, a gaming value data storage area 103A, and thus has a function as a value data storage means in the present invention. In the gaming value data storage area 103A, gaming value data is stored which represents the gaming value of the gaming IC medal 65 at the present moment as the first value data in the present invention. The RAM 103 also temporarily stores various kinds of data and so on calculated by the acceptance device CPU 101.

To the acceptance device CPU 101, a medal detecting unit 104 is also connected. The medal detecting unit 104, which is a gaming medal detecting means (a gaming medium detecting means) and a setting medal detecting means (a setting medium detecting means) in the present invention, detects the medals (the gaming IC medal 65 and setting IC medal 66) inserted through the medal insertion slot 49 (see FIG. 4). The acceptance device CPU 101 performs calculation associated with the inserted medals, based on a medal detection signal outputted from the medal detecting unit 104.

To the acceptance device CPU 101, the electronic tag reader/writer 105 is further connected. The electronic tag reader/writer 105, which is an identification information detecting means and a data detecting means in the present invention, reads the stored arcade ID and password from the arcade ID storage area 67A, 74A and the password storage area 67B, 74B of the electronic tag 67, 74 incorporated in the inserted gaming IC medal 65 or setting IC medal 66 (see FIGS. 9, 12), and further reads the stored number of credits from the credit number storage area 74C of the electronic tag 74. The electronic tag reader/writer 105 then inputs the read various kinds of information into the acceptance device CPU 101.

The acceptance device CPU 101 checks the various kinds of information against the confirmation arcade ID and password stored in the confirmation ID and password storage area 102A of the ROM 102, and determines whether or not the medal is the authorized gaming IC medal 65 or setting IC medal 66. Further, the acceptance device CPU 101 change the current gaming value data stored in the gaming value data storage area 103A (shown FIG. 16) of the RAM 103.

Further, regarding the setting IC medal 66, the acceptance device CPU 101 instructs the electronic tag reader/writer 105 to erase the gaming value data stored in the credit number storage area 74C of the setting IC medal 66 after changing of the gaming value data of gaming IC medal 65.

To the acceptance device CPU 101, the medal value display unit 50 is also connected. The medal value display unit 50 displays the number of credits to be added per gaming IC medal 65, based on the current gaming value of the gaming IC medal 65 stored in the gaming IC medal value data storage area 103A of the RAM 103.

To the acceptance device CPU 101, the error release switch 51, the separation switch 52, the housing unit opening/closing switch 56, a fixing device 106, a locking device 107, the medal return device 61, and a medal holding device 109 are separately connected. The acceptance device CPU 101 performs control, based on operation signals outputted by operation of the switches, to perform corresponding various operations. Specifically, upon operation of the error release switch 51, the acceptance device CPU 101 performs control for releasing the error state of the medal acceptance device 2.

Besides upon operation of the separation switch 52, the acceptance device CPU 101 allows for locking and release of the locked state of the fixing device 106 that fixes the body unit 44.

Further, upon operation of the housing unit opening/closing switch 56, the acceptance device CPU 101 allows for locking and release of the locked state of the locking device 107 that fixes the base portion 48.

To the acceptance device CPU 101, a data sending unit 110 is further connected. The data sending unit 110 sends the credit signal to the main body unit 89. The credit signal is information relating to the additional credits that the acceptance device CPU 101 acquires when the gaming IC medal 65 is inserted into the medal acceptance device 2, based on the gaming value data of the gaming IC medal 65 stored in the RAM 103.

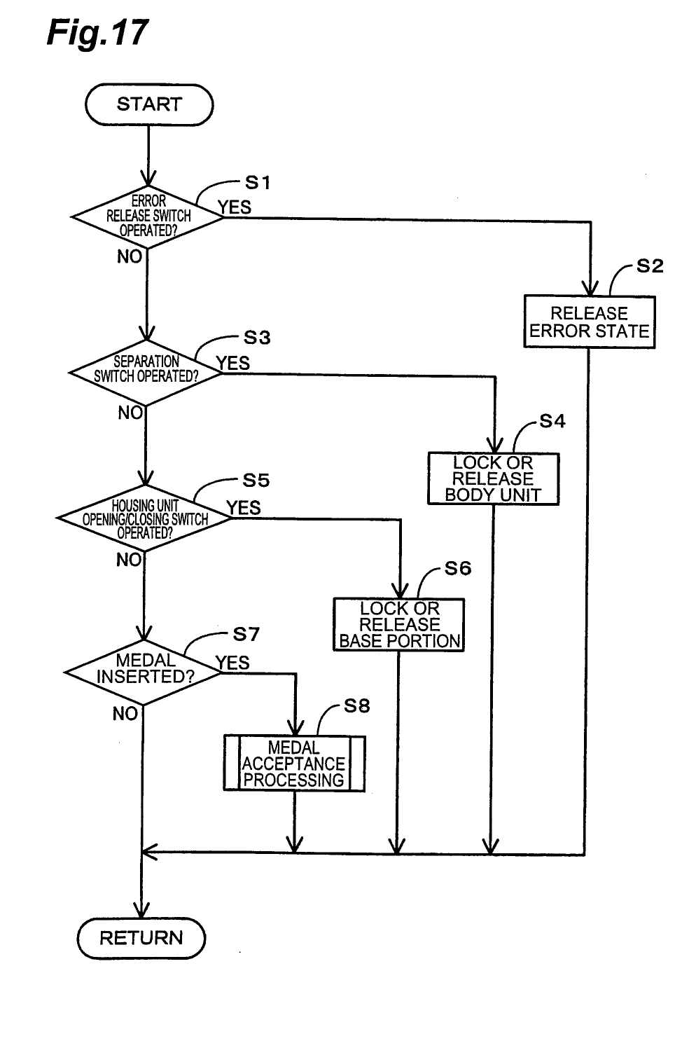

(Contents of Operation of Medal Acceptance Device) Subsequently, main processing to be executed in the medal acceptance device 2 will be described with reference to FIG. 17. FIG. 17 is a flowchart showing an operation procedure of the main processing in the medal acceptance device 2. The main processing is executed by the acceptance device CPU 101, following main processing programs stored in the ROM 102 and RAM 103 of the medal acceptance device 2.

First, in step (hereinafter, abbreviated as S) 1, the acceptance device CPU 101 determines whether the error release switch 51 is operated or not, based on the operation signal outputted by operation of the error release switch 51.

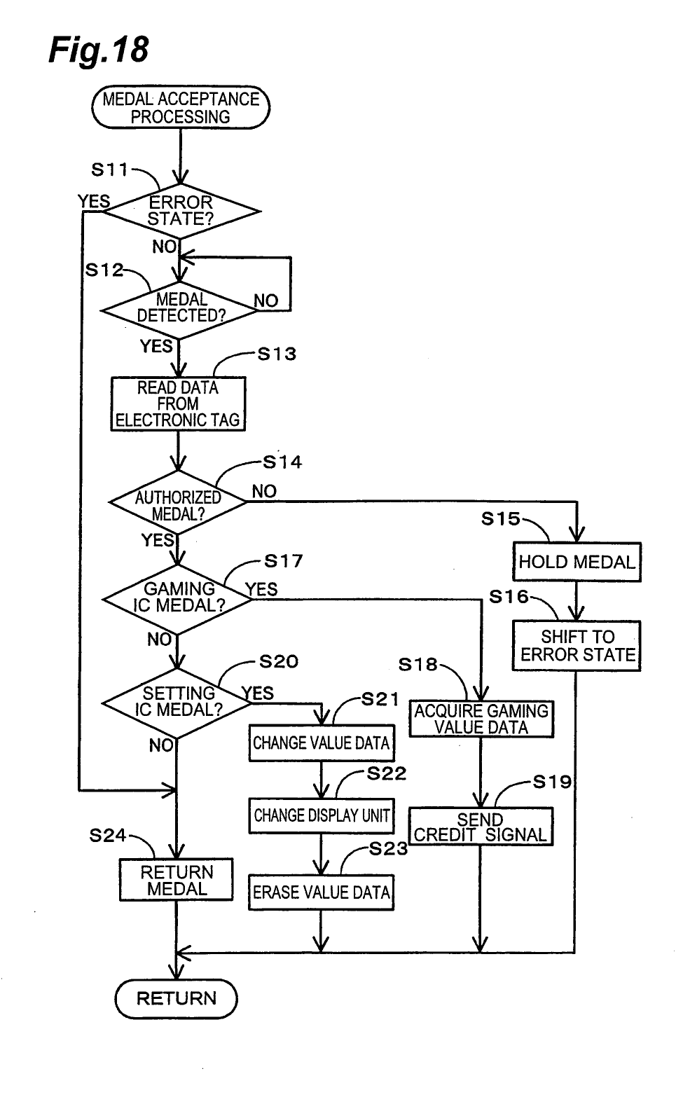

If the error release switch 51 is operated (S1: YES), the current error state of the medal acceptance device 2 is released (S2). The error state here means a state to which the medal acceptance device 2 shifts when a setting IC medal 66 or gaming IC medal 65 other than the authorized medal is inserted (see S14 to S16 in FIG. 18) and in which the character “E” indicating the error state is displayed on the medal value display unit 50 (see FIG. 6) and the medal return device 61 returns all of the medals inserted thereafter to the medal return slot 53. On the other hand, if the error release switch 51 is not operated (S1: NO), the procedure proceeds to S3.

Next, in S3, the acceptance device CPU 101 determines whether the separation switch 52 is operated or not, based on the operation signal outputted by operation of the separation switch 52.

If the separation switch 52 is operated (S3: YES), locking or release of the locked state of the fixing device 106 is performed according to the instruction from the acceptance device CPU 101 (S4). By releasing the locked state, the body unit 44 can be separated from the base portion 48 and the side walls 45, 46 and 47, allowing the unauthorized medal held in the medal holding unit 54 to be taken out. By locking, the body unit 44 can be fixed to the base portion 48 and the side walls 45, 46 and 47. On the other hand, if the separation switch 52 is not operated (S3: NO), the procedure proceeds to S5.

In S5, the acceptance device CPU 101 determines whether the housing unit opening/closing switch 56 is operated or not, based on the operation signal outputted by operation of the housing unit opening/closing switch 56.

If the housing unit opening/closing switch 56 is operated (S5: YES), locking or release of the locked state of the locking device 107 is performed according to the instruction from the acceptance device CPU 101 (S6). By releasing the locked state, the base portion 48 can be slid relative to the side walls 45, 46 and 47, allowing the medal housed in the medal housing unit 55 to be taken out. By locking, the base portion 48 can be fixed to the side walls 45, 46 and 47. On the other hand, if the housing unit opening/closing switch 56 is not operated (S5: NO), the procedure proceeds to S7.

Then, in S7, the acceptance device CPU 101 determines whether or not a medal is inserted through the medal insertion slot. The medal is inserted by a player or a clerk of the gaming arcade. If the medal is inserted (S7: YES), medal acceptance processing is executed (S8). On the other hand, if no medal is inserted (S7: NO), the main processing ends.

Next, the medal acceptance processing to be executed in the medal acceptance device 2 will be described with reference to FIG. 18. FIG. 18 is a flowchart showing an operation procedure of the medal acceptance processing executed in the medal acceptance device 2. The medal acceptance processing is executed by the acceptance device CPU 101 following medal acceptance processing programs stored in the ROM 102 and RAM 103 of the medal acceptance device 2.

First, in S11, the acceptance device CPU 101 determines whether or not the medal acceptance device 2 is in the error state. If it is in the error state (S11: YES), all of the inserted medals (including the gaming IC medal 65 and setting IC medal 66) are returned through the medal return slot 53 by the medal return device 61 (S24).

If the medal acceptance device 2 is not in the error state (S11: NO), the acceptance device CPU 101 determines whether or not the medal detection by the medal detecting unit 104 has been performed (S12). If no medal has been detected (S12: NO), the acceptance device CPU 101 waits until a medal is detected, whereas if a medal has been detected (S12: YES), the procedure proceeds to S13. Incidentally, the error state continues until it is released by the error release switch 51 (S2).

In subsequent S13, the acceptance device CPU 101 instructs the electronic reader/writer 105 to read the stored various kinds of data from the electronic tag 67, 74 (see FIG. 8, FIG. 12) incorporated in the detected gaming IC medal 65 or setting IC medal 66. The data to be read here include the arcade ID, the password, and the number of credits (see FIG. 9, FIG. 12). Then, the procedure proceeds to S14.

In S14, the acceptance device CPU 101 operates as a checking means and a determination means to perform, based on the data read in S13, the medal right/wrong determination of whether or not the inserted medal is any of the authorized gaming IC medal 65 and setting IC medal 66. The authorized gaming IC medal 65 and setting IC medal 66 are medals whose arcade IDs and passwords match the arcade ID and password stored in the confirmation ID and password storage area 102A of the ROM 102. In this case, the acceptance device CPU 101 checks the arcade ID and password read from the electronic tag 67, 74 against the confirmation ID and password stored in the confirmation ID and password storage area 102A of the ROM 102, and determines, depending on a match or no match based on the check result, whether or not the medal is the authorized IC medal. If the medal is determined to be the authorized IC medal (S14: YES), the procedure proceeds to S17, in which the inserted IC medal is housed in the medal housing unit 55. On the other hand, if the medal is determined not to be the authorized IC medal (S14: NO), the procedure proceeds to S15.

In S15, the acceptance device CPU 101 instructs the medal holding device 109 to hold the inserted unauthorized medal (for example, a medal purchased at another arcade or forged medal) in the medal holding unit 54 (S15). The medal held here can be taken out only by separating the body unit 44 (S4).

Subsequently, the procedure proceeds to S16, and in response to the holding of the unauthorized medal in the medal holding unit 54, the acceptance device CPU 101 operates as an error control means to perform control for the error state, thereby shifting the medal acceptance device 2 to the error state. In this event, the acceptance device CPU 101 instructs the medal value display unit 50 to display the character “E” indicating the error state (see FIG. 6), and causes the medal return device 61 to operate to return all of the medals inserted thereafter to the medal return slot 53.

Further, in S17, the acceptance device CPU 101 determines whether or not the inserted medal is the gaming IC medal 65 depending on the kind of the data read from the electronic tag 67, 74. If the medal is determined to be the gaming IC medal 65 (S17: YES), the procedure proceeds to S18, whereas if it is determined not to be the gaming IC medal 65 (S17: NO), the procedure proceeds to S20.

Then, in S18, the acceptance device CPU 101 accesses the RAM 103 to acquire the gaming value data of the gaming IC medal 65 stored in the gaming value data storage area 103A.

In subsequent S19, the acceptance device CPU 101 instructs the data sending unit 110 to send to the satellite main body unit 89 the credit signal of the number of credits to be added as the credits in player's hand, based on the gaming value data acquired in S18, and then the medal acceptance processing ends. Then, the satellite control CPU 91 receives the sent credit signal and increases the number of credits of the player stored in the RAM 93, based on the number of credits indicated by the credit signal.

On the other hand, if the inserted medal is not the gaming IC medal 65 (S17: NO), the procedure proceeds to S20, in which the acceptance device CPU 101 determines whether or not the inserted medal is the setting IC medal 66 depending on the kind of the data read from the electronic tag 67, 74. Incidentally, since the setting IC medal 66 includes four kinds of credit setting IC medals 70 to 73 as described above, the kind of the setting IC medal 66 is also determined in S20.

If the inserted medal is determined to be the setting IC medal 66 (S20: YES), the procedure proceeds to S21, whereas if it is determined not to be the setting IC medal 66 (S20: NO), the procedure proceeds to S24. In S21, the acceptance device CPU 101 operates as a data change means in the present invention to change the current gaming value data stored in the gaming value data storage area 103A of the RAM 103 (this gaming value data corresponds to the first value data in the present invention) to the gaming value data read from the credit number storage area 74C of the setting IC medal 66 (this gaming value corresponds to the second value data in the present invention). By this change, for example, when the setting IC medal 66 is the 30-credit setting IC medal 70, the gaming value data is changed to that of 30 credits, and when it is the 50-credit setting IC medal 71, the gaming value data is changed to that of 50 credits. Thus, in the medal acceptance device 2, the insertion of the setting IC medal 66 changes the number of credits displayed on the medal value display unit 50, and based on the changed number of credits, the gaming IC medal 65 is accepted. Besides, when the setting IC medal 66 is the 70-credit setting IC medal 72, the gaming value data is changed to that of 70 credits, and when the setting IC medal 66 is the 100-credit setting IC medal 73, the gaming value data is changed to that of 100 credits.

Subsequently, in S22, the display on the medal value display unit 50 is changed based on the number of credits changed in S21. Accordingly, the player and the clerk of the gaming arcade can easily know, from the number of credits displayed on the medal value display unit 50, the number of credits currently set to be added every time one gaming IC medal 65 is inserted. Thereafter, the procedure proceeds to S23.

In S23, the acceptance device CPU 101 instructs the electronic tag reader/writer 105 to erase the gaming value data stored in the credit number storage area 74C of the setting IC medal 66, with which the medal acceptance processing ends. In this S23, the electronic tag reader/writer 105 functions as a data erasing means in the present invention. The setting IC medal 66 from which the gaming value data has been erased is housed in the medal housing unit 55 together with the gaming IC medal 65. The setting IC medal 66 will have an appearance and contents of data in common with the gaming IC medal 65, after erasing of the contents of the credit number storage area 74C, and thereafter can be used as a gaming IC medal 65.

On the other hand, if the inserted medal is determined neither to be the setting IC medal 66 (S20: NO), the inserted medal is returned through the medal return slot 53 (S24), and then the medal acceptance processing ends.

As has been described above, in the medal acceptance device 2 according to this embodiment, when the setting IC medal 66 is inserted into the medal acceptance device 2, the gaming value data stored in the electronic tag 74 incorporated in the setting IC medal 66 is read by the electronic tag reader/writer 105 (S13), and the gaming value data of the gaming IC medal 65 stored in the RAM 103 is changed to the read gaming value data (the designated number of credits “30,” “50,” “70,” or “100”) (S21). Therefore, by performing the operation of inserting the setting IC medal 66, the gaming value per gaming IC medal 65 for use in the game can be changed without the necessity of huge facilities, systems, and so on, thus never increasing the cost on the gaming arcade side due to the change of the gaming value. Further, the gaming arcade can insert the setting IC medal 66 at a voluntary timing on the gaming arcade side to change the gaming value per gaming IC medal 65 with ease at a voluntary timing. Therefore, it is possible to change with ease the number of executable games, credits, or the like per amount of money of purchasing or borrowing medals, at a voluntary timing on the gaming arcade side, as well as to enhance the effect of attracting customers.

Further, the player does not need to bring a large quantity of medals and is never bothered with reservation of a place for them, so that the player never loses a desire to play games. In addition, the change in the gaming value per medal varies the gaming performance, enhancing the desire to play games of the player. Furthermore, the setting IC medal 66 inserted into the medal acceptance device 2, from which the gaming value data in the credit number storage area 74C is erased (S23), is housed in the medal housing unit 55 as a gaming IC medal 65 having no gaming value data and can be handled as the gaming IC medal 65. Accordingly, it is unnecessary to classify the medals housed in the medal housing unit 55 into the setting IC medals 66 and the gaming IC medals 65, and both of them are reusable as the gaming IC medals 65, thereby reducing the labor required for classifying the medals on the gaming arcade side.

Further, since the gaming IC medal 65 can be made a setting IC medal 66 by additionally writing the information of the credit number storage area 74C into the gaming IC medal 65 through use of the data writing device (not shown), a new setting IC medal 66 can be easily created from the gaming IC medal 65.

Moreover, the arcade IDs and passwords are stored in the gaming IC medal 65 and the setting IC medal 66, respectively, and checked against the confirmation arcade ID and password stored in the ROM 102, whereby the right/wrong determination of whether or not the inserted medal is the authorized IC medal, is performed (S14). Consequently, it is possible to surely eliminate unauthorized medals such as forged medals, medals purchased or the like at other arcades, and so on (S15).

When the inserted medal is determined not to be the authorized medal (S14: NO), the inserted medal is held (S15), and the error display (a warning display in the present invention) is performed on the medal value display unit 50, and then all of the medals inserted thereafter are paid out through the medal payout slot 53 (S16, S21). Thus, acceptance of medals from a player, who has used an unauthorized medal, can thereafter be prevented. Furthermore, it is also possible to issue a warning to the player as well as to inform the gaming arcade side of the fact. Accordingly, the medal acceptance device 2 never allows the player who has committed an injustice to continue playing medal games any more.

Furthermore, the medal value display unit 50 displays the gaming value of the gaming IC medal 65 based on the gaming value data stored in the RAM 103 (S22). Therefore, the player and the gaming arcade side can easily know the number of credits to be added every time one gaming IC medal 65 is inserted.

Note that the present invention is not limited to the above-described embodiment, but various improvements and modifications may be made, as a matter of course, within a scope without departing from the spirit of the present invention.

For example, one medal acceptance device 2 is provided for one satellite 5 in this embodiment, but the medal acceptance device 2 may be shared among a plurality of satellites 5.

Although the medal acceptance device 2 is incorporated in the roulette gaming machine 1, it may be provided together with medal games such as a slot machine. The description is made taking as an example the medal acceptance device 2 using medals as gaming media. The present invention is also applicable to gaming medium acceptance devices using gaming media such as coins, tokens, chips, and so on, in addition to the medals. The present invention is also applicable to, for example, a chip acceptance device for use in a table game using chips. The form of a medal is not limited to circle form.

Although the non-contact type electronic tag is used as the electronic tag 67, 74 in this embodiment, a contact type electronic tag may be used.

Besides, when the device shifts to the error state, all of the medals inserted thereafter are returned through the medal return slot 53 in this embodiment. Alternatively, it is also possible to provide a shutter over the medal insertion slot 49 so that when the device shifts to the error state, the shutter is closed to prevent medals from being inserted thereafter through the medal insertion slot 49.

Since the number of credit is stored in electronic tags 74 in addition to the arcade ID and password, the gaming arcade side can easily create a setting IC medal 66 by storing additionally the number of credit in gaming IC medal 65.

It is apparent that various embodiments and modifications of the present invention can be embodied, based on the above description. Accordingly, it is possible to carry out the present invention in the other modes than the above best mode, within the following scope of claims and the scope of equivalents.

1. A medal acceptance device comprising a gaming medal detecting means detecting a gaming medal inserted through a medal insertion slot and a value data storage means storing first value data representing a gaming value of said gaming medal, said device comprising:
a setting medal having a data storage part capable of storing second value data different from the first value data representing the gaming value of said gaming medal;
a setting medal detecting means detecting said setting medal inserted through the medal insertion slot;
a data detecting means detecting the second value data stored in the data storage part of said setting medal inserted through the medal insertion slot;
a data change means changing the first value data stored in said value data storage means to the second value data detected by said data detecting means; and
a data erasing means erasing the second value data stored in the data storage part of said setting medal detected by said setting medal detecting means.

2. The medal acceptance device according to claim 1, wherein:
said setting medal has medal identification information stored in the data storage part;
said gaming medal has an identification information storage part in which medal identification information is stored; and
said device further comprises:
a confirmation identification information storage means storing confirmation identification information for determining whether said gaming medal and setting medal are right or wrong;
an identification information detecting means detecting medal identification information of said setting medal or said gaming medal inserted through the medal insertion slot;
a checking means checking the medal identification information detected by said identification information detecting means against the confirmation identification information; and
a determination means performing, based on a check result by said checking means, a right/wrong determination of whether or not a medal inserted through the medal insertion slot is an authorized medal.

3. The medal acceptance device according to claim 1, further comprising an error control means performing control to shift to an error state in which medal insertion through the medal insertion slot is not accepted, when said determination means determines that said setting medal or gaming medal inserted through the medal insertion slot is not an authorized medal.

4. The medal acceptance device according to claim 1, further comprising a display means displaying the first value data or the second value data.

5. The medal acceptance device according to claim 2, further comprising a medal holding means holding, when said determination means determines that said setting medal or gaming medal inserted through the medal insertion slot is not an authorized medal, said setting medal or gaming medal determined by said determination means.

6. The medal acceptance device according to claim 4, wherein said display means performs a warning display when said determination means determines that said setting medal or gaming medal inserted through the medal insertion slot is not an authorized medal.

7. The medal acceptance device according to claim 3, further comprising an error release means for releasing the error state.

8. The medal acceptance device according to claim 2, further comprising a medal housing unit housing both said setting medal and gaming medal determined to be authorized medals by said determination means.

9. A medal acceptance device comprising a gaming medal detecting device detecting a gaming medal inserted through a medal insertion slot and a value data storage device storing first value data representing a gaming value of said gaming medal, said device comprising:
a setting medal having a data storage part capable of storing second value data different from the first value data representing the gaming value of said gaming medal;
a setting medal detecting device detecting said setting medal inserted through the medal insertion slot;
a data detecting device detecting the second value data stored in the data storage part of said setting medal inserted through the medal insertion slot;
a data change unit changing the first value data stored in said value data storage device to the second value data detected by said data detecting device; and
a data erasing unit erasing the second value data stored in the data storage part of said setting medal detected by said setting medal detecting means.

10. The medal acceptance device according to claim 9, wherein:
said setting medal has medal identification information stored in the data storage part;
said gaming medal has an identification information storage part in which medal identification information is stored; and
said device further comprises:
a confirmation identification information storage device storing confirmation identification information for determining whether said gaming medal and setting medal are right or wrong;
an identification information detecting device detecting medal identification information of said setting medal or said gaming medal inserted through the medal insertion slot;
a checking unit checking the medal identification information detected by said identification information detecting device against the confirmation identification information; and
a determination unit performing, based on a check result by said checking unit, a right/wrong determination of whether or not a medal inserted through the medal insertion slot is an authorized medal.

11. The medal acceptance device according to claim 9, further comprising an error control unit performing control to shift to an error state in which medal insertion through the medal insertion slot is not accepted, when said determination unit determines that said setting medal or gaming medal inserted through the medal insertion slot is not an authorized medal.

12. The medal acceptance device according to claim 9, further comprising a display device displaying the first value data or the second value data.

13. The medal acceptance device according to claim 10, further comprising a medal holding device holding, when said determination unit determines that said setting medal or gaming medal inserted through the medal insertion slot is not an authorized medal, said setting medal or gaming medal determined by said determination unit.

14. The medal acceptance device according to claim 12, wherein said display device performs a warning display when said determination unit determines that said setting medal or gaming medal inserted through the medal insertion slot is not an authorized medal.

15. The medal acceptance device according to claim 11, further comprising an error release device for releasing the error state.

16. The medal acceptance device according to claim 10, further comprising a medal housing unit housing both said setting medal and gaming medal determined to be authorized medals by said determination unit.
